(19) United States
(12) Patent Application Publication
(10) Pub. No.: US 2016/0037134 A1
(43) Pub. Date: Feb. 4, 2016

(54) METHODS AND SYSTEMS OF SIMULATING TIME OF DAY AND ENVIRONMENT OF REMOTE LOCATIONS

(71) Applicants: Todd MEDEMA, Pittsburgh, PA (US); SCOTT MARTIN, Pittsburgh, PA (US)

(72) Inventors: Todd MEDEMA, Pittsburgh, PA (US); SCOTT MARTIN, Pittsburgh, PA (US)

(21) Appl. No.: 14/811,831

(22) Filed: Jul. 29, 2015

Related U.S. Application Data
(60) Provisional application No. 62/031,527, filed on Jul. 31, 2014.

(51) Int. Cl. H04N 7/18; H04N 7/20; G06T 7/00; G06F 17/30; G06K 9/00

(52) U.S. Cl. CPC H04N 7/183; G06F 17/30247; G06K 9/00697; G06K 9/00671; G06T 7/004; G06T 7/0028; H04N 7/20; G06T 2207/10016; G06T 2207/30232; G06T 2207/30244; G06T 2210/61

(57) ABSTRACT

In one embodiment, a method includes the step of capturing, at a remote location with a set of digital cameras, a series of digital photographs of a landscape, wherein the series of digital photographs is taken over at least a twenty-four hour period, and wherein the capturing is managed by a remote computing device that comprises a computer process, a memory and computer networking system. The method includes the step of positioning the set of digital cameras to match an angle of a computer-display screen. The method includes the step of obtaining a location data of the set of the digital cameras. The method includes the step of communicating, with the computer networking system of the remote computing device to a server computing system, wherein the server computing system comprises at least one computer processor that includes processes that manage the display of all or a portion of the series of digital photographs on one or more display systems.

### CROSS-REFERENCE TO RELATED APPLICATIONS

This application claims priority to U.S. provisional patent application No. 62/031,527, and filed on 31 Jul. 2014.

### BACKGROUND

1. Field

This application relates generally to digital image display, and more specifically to a system, article of manufacture and simulating time of day and environment of remote locations.

2. Related Art

Computers with display are increasingly located throughout a user's living and work spaces. The Internet has enabled computers to obtain information, such as digital images, lion) practically any location on the planet. Users may desire to experience more naturalistic views of remote locations on their computing devices. Accordingly, improvements are sought in the capture and in the display of a series of digital images of remote locations.

### BRIEF SUMMARY OF THE INVENTION

In one aspect, a computerized system for simulating time of day and environment of a remote location with a series of digital images of said remote location includes a remote computing device comprising a digital camera, a location determination system, a microprocessor, a clock and a wireless communication transceiver computing device programmed to obtain a series of digital images of scene at a remote location using the digital camera, a time stamp for each of digital image, include a geo-location of the remote location, and transmit the series digital images, the geo-location of the remote location and the time stamp for each of digital image. A server includes a central processing unit, a memory, and the digital images, the geo-location of the remote location and the time stamp for each of digital image from the wireless communication transceiver of the remote computing device, the memory having the series of the digital images, the geo-location of the remote location, the time stamp for each of digital image. The central processing unit, of the server is programmed to implement the steps of: determine a display device location; determine a date of display of the series of the digital image; determine a set of display instructions for the series of digital images wherein a playback of the series of digital images matches a length of the date of display at the display device location; and transmit the series of digital images and the length of display for each digital image to the display device through a computer network.

In another aspect, a method includes the step of capturing, at a remote location with a set of digital cameras, a series of digital photographs of a landscape, wherein the series of digital photographs is taken over at least a twenty-four hour period, and wherein the capturing is managed by a remote computing device that comprises a computer process, a memory and computer networking system. The method includes the step of positioning the set of digital cameras to match an angle of a computer-display screen. The method includes the step of obtaining a location data of the set of the digital cameras. The method includes the step of communicating, with the computer networking system of the remote computing device to a server computing system, wherein the server computing system comprises at least one computer processor that includes processes that manage the display of all or a portion of the series of digital photographs on one or more display systems. The method includes the step of storing the series of digital photographs, the location of the set of digital cameras the angles of each digital camera in a memory of the server computing system. The method includes the step of determining a set of display instructions for the series of digital photographs wherein a playback of the series of digital photographs matches a length of a specified display period based on the geolocation and date of display for the one or more display systems. The method includes the step of communicating the set of display instructions to the one or more display systems.

### BRIEF DESCRIPTION OF THE DRAWINGS

The present application can be best understood by reference to the following description taken in conjunction with the accompanying figures, in which like parts may be referred to by like numerals.

FIG. 1 depicts a process for long-duration time lapse photography is used for time-keeping and/or weather-indication, according to some embodiments.

FIG. 2 illustrates an example method of obtaining multiple digital images for integration into a virtual environment simulator, according to some embodiments.

FIG. 3 illustrates an example process for temporal mapping of digital photographs, according to some embodiments.

FIG. 4 illustrates an example system for simulating time of day and environment of remote locations, according to some embodiments.

FIG. 5 is a block diagram of a sample computing environment that can be utilized to implement various embodiments.

FIG. 6 depicts an exemplary computing system that can be configured to perform any one of the processes provided herein.

FIG. 7 illustrates an example screen shot of pseudocode illustrating a process for synchronizing events in a series of digital images between two different geolocations, according to some embodiments.

The Figures described above are a representative set, and are not an exhaustive with respect to embodying the invention.

### DESCRIPTION

Disclosed are a system, method, and article of manufacture for simulating time of day and environment of remote locations. The following description is presented to enable a person of ordinary skill in the art to make and use the various embodiments. Descriptions of specific devices, techniques and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Example Definitions

Digital photography can be a form of photography that uses cameras containing arrays of electronic photodetectors to capture images focused by a lens, as opposed to exposure on photographic film. The captured images are digitized and stored as a computer file ready for further digital processing, viewing, etc.

Global Positioning System (GPS) is a space-based navigation system that provides location and time information in all weather conditions, anywhere on or near the earth where there is an unobstructed line of sight to four or more GPS satellites

Mobile device can be any portable user-side computing system. Example mobile devices include, inter alia: smart phones, smart watches, head-mounted displays, other wearable computers, tablet computers, laptop computers, etc.

Virtual Reality (VR) and/or other immersive multimedia or computer-simulated life systems can be used to replicate an environment that simulates physical presence in places in the real world or imagined worlds. Virtual reality can recreate sensory experiences, which include virtual taste, sight, smell, sound, and touch.

Virtual environment simulators can include any software, program or system that implements, manages and controls multiple virtual environment instances.

### Exemplary Methods

A process in which a real or virtual landscape is photographed continuously or rendered over the period of at least twenty-four (24) hours and, through one or more screens, replayed in real time scale to match solar positioning for a reference location. This serves as a time-keeping device, indicating the current time via the time of day in the displayed picture, and can be expanded to show current weather (by photographing the same location at different weather states, and playing back the set of photographs that match the current weather). In contrast to accelerated time lapse playback, as in some implementations, the time lapse is displayed in real time scales as a time- and weather-telling device.

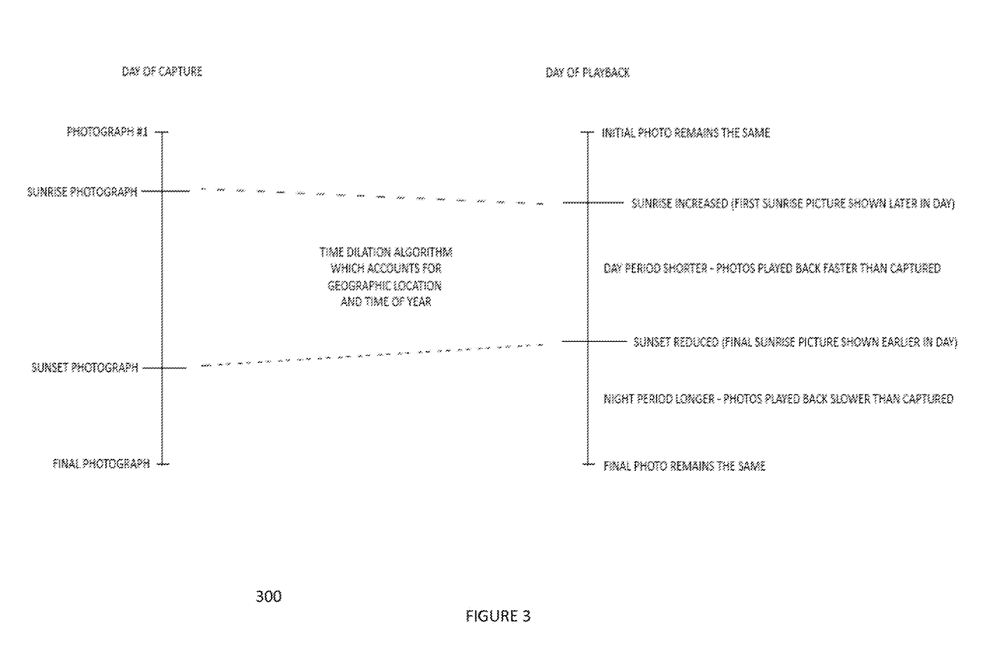

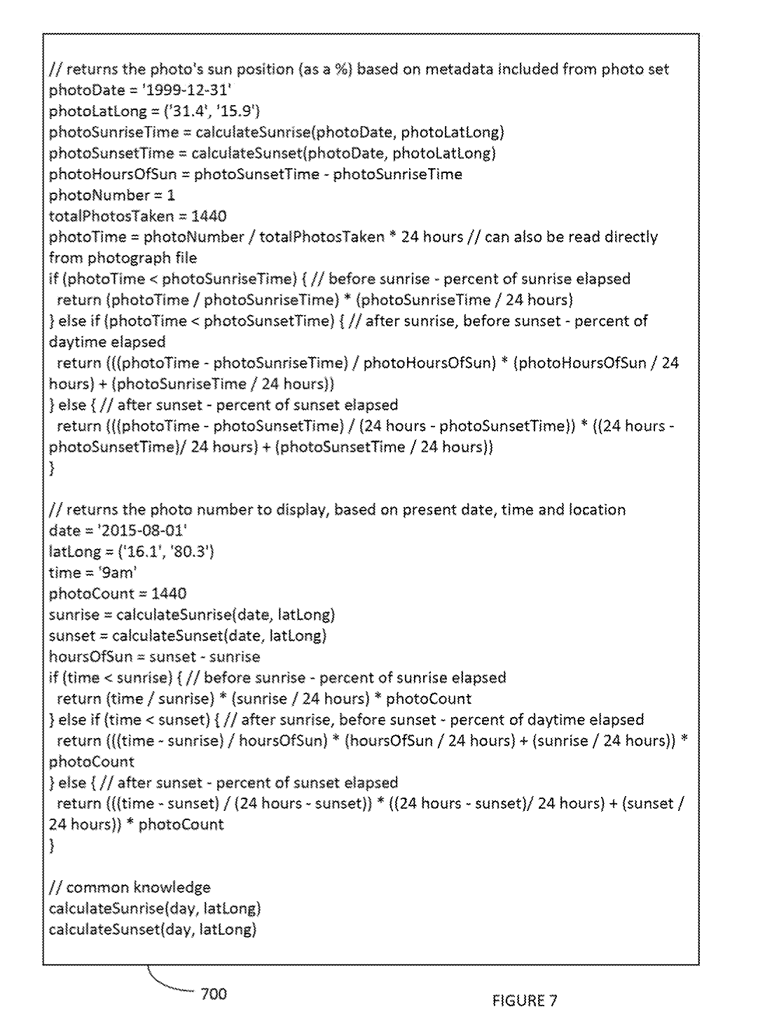

In some implementations, multiple cameras are positioned to correspond to expected screen positions, leading to more realistic viewing angles and reduced warping. The timekeeping device can be used either to indicate current time and weather, or, as a time zone clock, portraying the time and weather of the pictured location. To properly display the current time, a sun position-matching algorithm can be applied to correct the difference between sunrise/sunset times when and where the photographs were captured, and when and where they are being displayed (e.g. see FIG. 3 and FIG. 7 infra).

Unlike other options to present this information (e.g. a live Webcam feed), this methodology allows the creator to select a wider variety of locations that may not be amenable to permanent Webcam installation, as well as enabling the creator to artistically review and enhance footage before it is displayed to users. In some implementations, user may elect to view the remote location as though it was located in the same general time zone, e.g., with synchronized sun rises and sun sets. For example, an island location on the other side of the world could be rendered as thought it was currently the same time of day and/or weather as at the user's location.

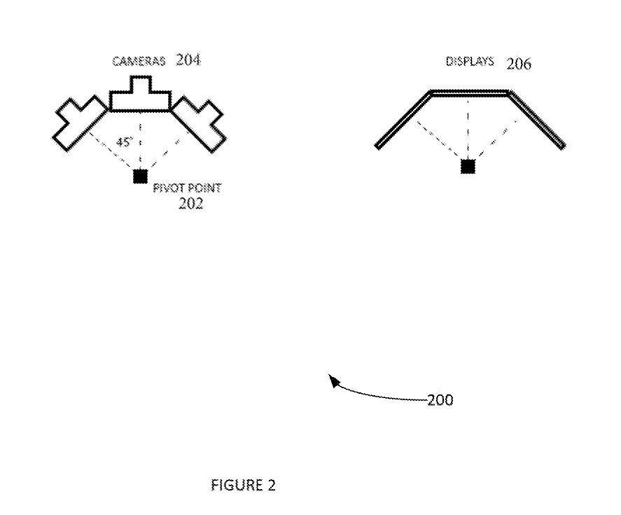

In some implementations, the user can select to match the time of day, weather conditions, or both. In some cases, the displayed weather conditions are selected via reference to a local weather database (e.g., weather.com®). In some implementations, the user may select a category of locations, such as, inter alia, Caribbean islands, or national parks, to be displayed in rotation or at random or at a selected interval. In same implementations, the user may select from soundtracks, e.g. captured audio, music, nature sounds, or water sounds, available for a given location or category of locations. In some implementations, a user may calibrate the displayed positioning of the pictures on the multiple screens to account for screen frames or spacing. In some implementations, a user may interact with select objects in the time lapse images, e.g., accelerating a passing boat with the cursor. In some implementations, short segments of video may be combined with photographs to create a continuous sense of movement over 24 hours, without requiring a continuous video. Methods of display include a digital picture frame, mobile application or live wallpaper, a computer wallpaper application, or a virtual environment simulator (whereby multiple large displays at different angles fill the user's vision, see FIG. 2 infra).

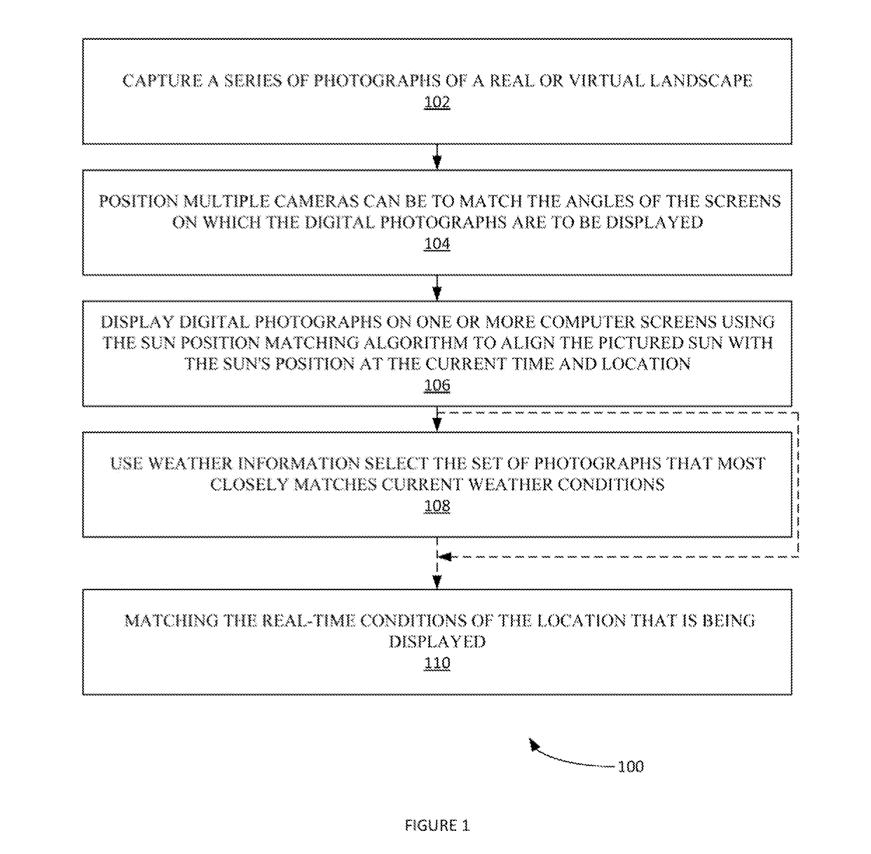

FIG. 1 depicts a process 100 of long-duration time lapse photography used for time-keeping and/or weather-indication, according to some embodiments. In step 102 of process 100, a series of photographs of a real or virtual landscape can be captured. It is noted that the digital photographs can be obtained over at least a twenty-four (24) hours (e.g. one full day cycle). This period can include multiple weather cycles. In step 104, multiple cameras can be positioned to match the angles of the screens on which the digital photographs are to be displayed. In step 106, the digital photographs can be displayed on one or more computer screens (e.g. a mobile device's touchscreen, a virtual-reality display, a tablet computer touchscreen, etc.) using the sun position matching algorithm to align the pictured sun with the surfs position at the current time and location. In step 108, weather information can be used to select the set of photographs that most closely matches current weather conditions. Optionally, in step 110, instead of and/or in addition to the steps for matching time and weather at the user's location, process 100 can include matching the real-time conditions of the location that is being displayed.

FIG. 2 illustrates an example method 200 of obtaining multiple digital images for integration into a virtual environment simulator, according to some embodiments. Method 200 illustrates an arrangement of camera(s) 204 and display(s) 206 around a pivot point 202. Method 200 is provided by way of example and not limitation. It is noted that various virtual-reality (VR) methodologies can be utilized (e.g. simulation-based VR, projector VR, Desktop-based VR, etc.) can be utilized. Additionally, various methods of panoramic photography can be utilized as well to obtain digital images for integration into a VR display.

FIG. 3 illustrates an example process 300 for temporal mapping of digital photographs, according to some embodiments. Process 300 can include a time dilation algorithm that accounts to a displaying computing device's location and a current time of year. In this way, the time of day and environment at ‘distant’ (e.g. with respect to the displaying computing device) locations can be simulated at an appropriate time on a displaying computing device. For example, a digital video can be taken at a ‘distant’ location at a specified day (e.g. the day of capture). Later on, at another time of the year (e.g. when a day is shorter or longer) and at another latitude/longitude, the displaying computing device can include a functionality that modifies the digital video (e.g. shortens length of the digital video, lengthens the digital video) to match the current day length (e.g. day of playback) at the current day/location. It is noted that a video can also be a series of ‘still’ digital photographs that are each shown for a period of time in a specified temporal sequence. For example, ‘n’ number of still digital photographs can be obtained at a location at a specified periodicity (e.g. a digital photograph(s) is obtained every minute, etc). In one example, a set of sequential digital photographs can be obtained for a given location at a given day. This set of sequential digital photographs can be modified to accommodate the present diurnal cycle of the displaying computing device's current location and calendar day. In one example, certain digital photographs can be removed from the set of sequential digital photographs to accommodate a shorter day of display than the day of capture. In another example, certain digital photographs can be re-displayed and/or displayed for a longer period to accommodate a longer day of display than the day of capture.

In a particular example, process 300 shows that the initial digital photograph can remain the same. The day of capture set of digital images may have been taken at a specified rate (e.g. one digital image per minute). The day period of the day of playback may be shorter. One playback method that can be utilized is provided in FIG. 3. If the day/night of the playback is shorter than the day of capture, the playback rate of digital photographs can be at a slower frequency than the capture rate frequency. If the day/night of playback is longer than the day of capture, the playback rate can be a faster frequency than the capture rate frequency. Digital photographs can also be repeated and/or removed in order in some example embodiments. It is noted that the final digital photograph of two series between the day of capture and the day of playback can also be identical (e.g., see the algorithm provided in FIG. 7 infra).

### Systems and Architecture

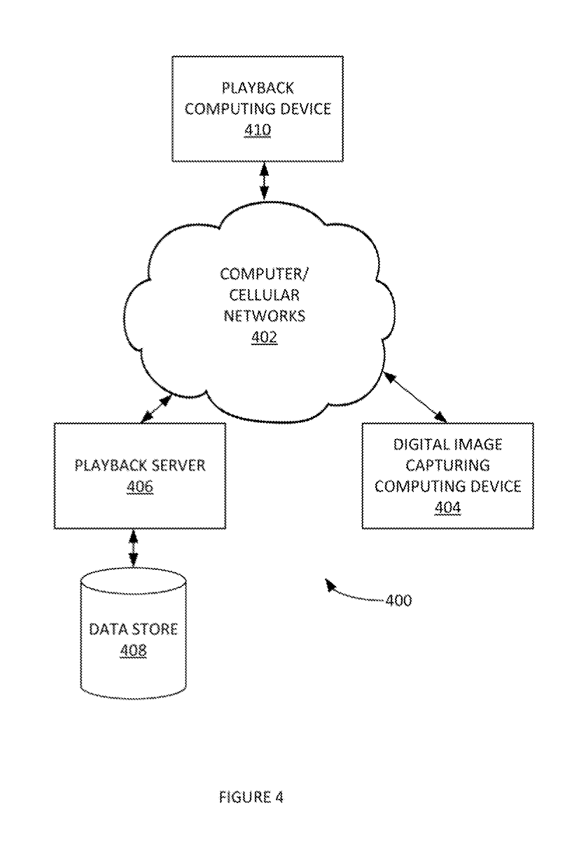

FIG. 4 illustrates an example system 400 for simulating time of day and environment of remote locations, according to some embodiments. System 400 can include a digital image capturing computing device(s) 404. Digital image capturing computing device 404 can include one or more digital images. These digital images can be provided to playback server 406 and stored in datastore 408. Playback server 406 can implement various algorithms to map the day length of the digital images to the day length of playback computing device 410. Playback server 406 can implement the processes of FIGS. 1-3 supra. In some examples, playback computing device 410 can implement these functionalities in a client-side application. It is noted that playback server 406 can be implemented in a cloud-computing environment.

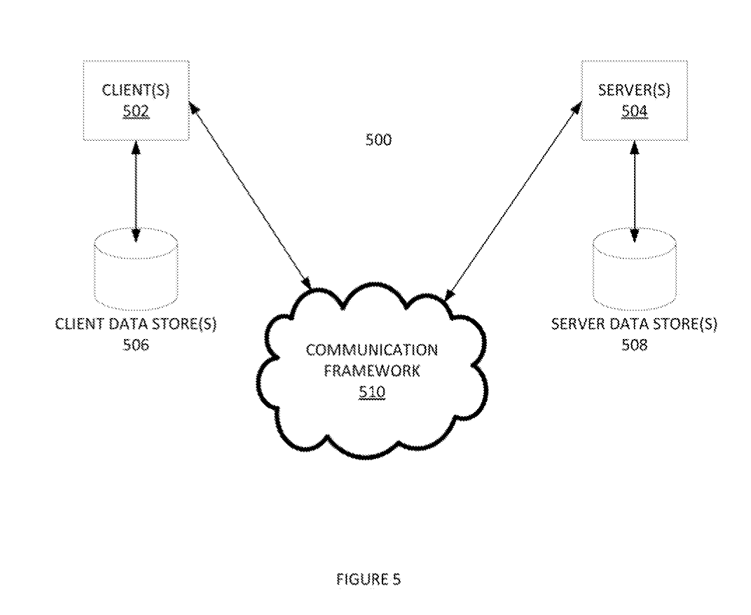

FIG. 5 is a block diagram of a sample computing environment 500 that can be utilized to implement various embodiments. The system 500 further illustrates a system that includes one or more client(s) 502. The client(s) 502 can be hardware and/or software (e.g., threads, processes, computing devices). The system 500 also includes one or more server(s) 504. The server(s) 504 can also be hardware and/or software (e.g., threads, processes, computing devices). One possible communication between a client 502 and a server 504 may be in the form of a data packet adapted to be transmitted between two or more computer processes. The system 500 includes a communication framework 510 that can be employed to facilitate communications between the client(s) 502 and the server(s) 504. The client(s) 502 are connected to one or more client data store(s) 506 that can be employed to store information local to the client(s) 502. Similarly, the server(s) 504 are connected to one or more server data store(s) 508 that can be employed to store information local to the server(s) 504.

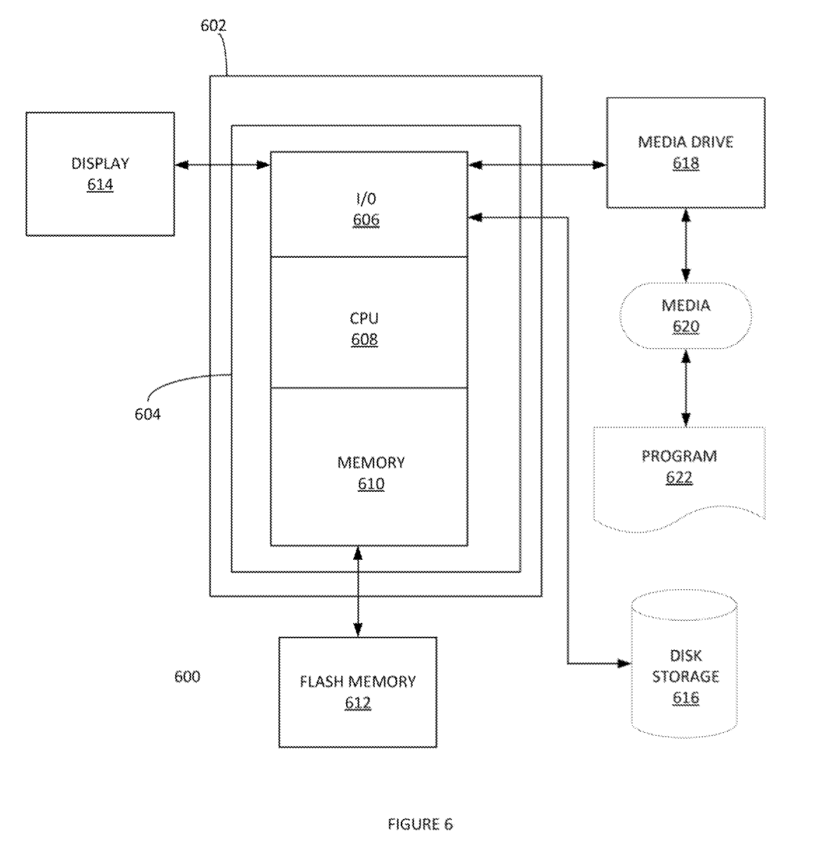

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Additional Processes and Systems

FIG. 7 illustrates an example screen shot 702 of pseudocode illustrating a process 700 for synchronizing events in a series of digital images between two different geolocations, according to some embodiments. Process 700 can be utilized to synchronize a sunrise, sunset, weather events, and/or other event between two different locations. For example, process 700 can be used for time dilation and/or time expansion calculations. The various dates, latitude and longitude values, number of digital photographs taken, etc. provided in screen shot 702 are provided by way of example and not of limitation. Other locations and dates can be input into process 700 in other examples. Process 700 also include a sun position-matching algorithm can be applied to correct the difference between sunrise/sunset times when and where the photographs were captured, and when and where they are being displayed.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including, using means for achieving the various operations). Accordingly the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A system for simulating time of day and environment of remote locations, comprising:
at least one computer processor disposed in a server; and
logic executable by the at least one computer processor, the logic configured to implement a method, the method comprising:
obtaining, with a digital camera, series of digital photographs a landscape in a specified location and a specified date, wherein the series of digital photographs is obtained for a specified period of time;
positioning two or more digital cameras to match a plurality of angles of a set of screens on which the digital photographs are assigned to be displayed; and
digital photographs can be displayed on one or more computer screens using the sun position matching algorithm to align the pictured sun with the sun's position at the current time and location.

2. The system of claim 1, wherein the series of digital photographs is of a real landscape or a virtual landscape.

3. The system of claim 2, wherein weather information can be used to select the set of photographs that most closely matches current weather conditions.

4. A computerized-system for simulating time of day and environment of a remote location with a series of digital images of said remote location comprising:
a remote computing device comprising a digital camera, a location determination system, a microprocessor, a clock and a wireless communication transceiver computing device programmed to obtain a series of digital images of scene at a remote location using the digital camera, a time stamp for each of digital image, include a geo-location of the remote location, and transmit the series digital images, the geo-location of the remote location and the time stamp for each of digital image;
a server comprising a central processing unit, a memory, and the digital images, the geo-location of the remote location and the time stamp for each of digital image from the wireless communication transceiver of the remote computing device, the memory having the series of the digital images, the geo-location of the remote location, the time stamp for each of digital image;
and the central processing unit of the server programmed to:
determine a display device location;
determine a date of display of the series of the digital image;
determine a set of display instructions for the series of digital images wherein a playback of the series of digital images matches a length of the date of display at the display device location; and
transmit the series of digital images and the length of display for each digital image to the display device through a computer network.

5. The computerized system of claim 4, wherein the location determination module comprises a Global Positioning System ((GPS) receiver unit that determines the geo-location of the remote location.

6. The computerized system of claim 5, wherein the series of digital images comprises a digital video.

7. The computerized system of claim 6, wherein the date of display comprises a first period, and wherein the first period comprises a display location sunrise to a display location sunset period.

8. The computerized system of claim 7, wherein the series of digital images is obtained for a single period by the remote computing device, and wherein the single period comprises a remote location sunrise to a remote location sunset period.

9. The computerized system of claim 8, wherein the computer network comprises the Internet.

10. The computerized system of claim 9, wherein the central processing unit of the server programmed to calculate a length of display for each digital image the series of digital images wherein a playback of the series of digital images matches a length of the date of display at the display device location.

11. The computerized system of claim 9, wherein the central processing unit of the server programmed to determine a number of a subset of digital images to be displayed selected from the series of digital images based on the display device location and the date of display of the series of the digital image.

12. The computerized system of claim 9, wherein a sun position-matching algorithm is applied to correct the difference between a remote sunrise/sunset period and a display sunrise/sunset period.

13. A method comprising:
capturing, at a remote location with a set of digital cameras, a series of digital photographs of a landscape, wherein the series of digital photographs is taken over at least a twenty-four hour period, and wherein the capturing is managed by a remote computing device that comprises a computer process, a memory and computer networking system;
positioning the set of digital cameras to match an angle of a computer-display screen;
obtaining a location data of the set of the digital cameras;
communicating, with the computer networking system of the remote computing device to a server computing system, wherein the server computing system comprises at least one computer processor that includes processes that manage the display of all or a portion of the series of digital photographs on one or more display systems;
storing the series of digital photographs, the location of the set of digital cameras the angles of each digital camera in a memory of the server computing system;
determining a set of display instructions for the series of digital photographs wherein a playback of the series of digital photographs matches a length of a specified display period based on the geolocation and date of display for the one or more display systems; and
communicating the set of display instructions to the one or more display systems.

14. The method of claim 13 further comprising:
displaying the series of digital photographs on the one or more display systems using a sun-position matching algorithm that aligns a digital-image of the sun with a sun position at a current display time and location.

15. The method of claim 14 further comprising:
using a weather information to select the set of photographs that most closely matches a current weather condition of the one or more display devices.

16. The method of claim 13, wherein instead of matching time and weather at the user's location, matching the real-time conditions of the location that is being displayed.

17. The method of claim 13, wherein the server computing system is implemented in a cloud-computing platform.

18. The method of claim 17, wherein the at least a twenty-four hour period comprises multiple weather cycles.
